(19) United States
(12) Patent Application Publication
(10) Pub. No.: US 2013/0046593 A1
(43) Pub. Date: Feb. 21, 2013

(54) FACILITATING A PURCHASED PRODUCT'S MAINTENANCE AND REPLACEMENT

(71) Applicants: Jürg von Känel, Mahopac, NY (US); Peter K. Malkin, Ardsley, NY (US); Jacquelyn A. Martino, Cold Spring, NY (US)

(72) Inventors: Jürg von Känel, Mahopac, NY (US); Peter K. Malkin, Ardsley, NY (US); Jacquelyn A. Martino, Cold Spring, NY (US)

(73) Assignee: INTERNATIONAL BUSINESS MACHINES CORPORATION, Armonk, NY (US)

(21) Appl. No.: 13/212,724

(22) Filed: Aug. 18, 2011

(51) Int. Cl. G06Q 40/00; G06Q 30/00

(52) U.S. Cl. 705/14.4; 705/39

(57) ABSTRACT

An ownership management system automatically may generate cost model of owning an object, schedule savings to fund the object and pay for the ownership of the object based on the cost model.

### FIELD

The present application relates generally to computers and computer applications, and particularly to facilitating a purchased product's maintenance and replacement.

### BACKGROUND

It is usually difficult for individuals to determine the full cost of ownership for large ticket items, e.g., the cost incurred over the long term over owning an item such as for maintenance and replacement. For example, when buying a home, while monthly payments may be considered, longer term maintenance costs such as for a new roof or painting may be overlooked. The current state of the art is limited to replacement cost calculators found online and/or custom spreadsheets developed by the would-be owner. Drawbacks of such solutions are that they are overly simplified (online tools) or incomplete (custom tools).

### BRIEF SUMMARY

A method for facilitating ownership of a given object, in one aspect, may include generating an ownership model associated with the given object, scheduling automatic saving to fund the ownership of the given object based on the ownership model, and automatically paying for the ownership of the given object with the automatically saved funds.

A system for facilitating ownership of a given object, in one aspect, may include an ownership management module operable to generate an ownership model associated with the given object. The ownership management module may be further operable to schedule automatic saving to fund the ownership of the given object based on the ownership model. The ownership management module may be also operable to automatically pay for the ownership of the given object with the automatically saved funds.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a flow diagram illustrating a methodology of the present disclosure in one embodiment.

FIG. 2 is a diagram showing components for facilitating a purchased product's maintenance and replacement in the present disclosure in one embodiment.

### DETAILED DESCRIPTION

The present disclosure in one embodiment may provide methods for specifying a potential purchase, calculating its long-term cost of ownership, and may include replacement savings planning and options for calculating “keep or sell/trade” during the viable lifetime of the item.

An ownership management service, a methodology of providing the service, a system for providing the service is presented in one embodiment of the present disclosure, where (1) a user is provided with a financial saving plan related to a given purchase, including coverage of maintenance and replacement costs; and (2) where the user can have their support needs (e.g., maintenance and replacement) broadcast (e.g., when needed, for instance, when the car needs brakes, or when the refrigerator needs to be replaced) so, for example, that related support services can bid for the user's business.

The following usage scenarios are examples of a service that illustrate one or more services that may be provided by the methodology of the present disclosure in one embodiment.

Scenario #1:

User A would like to find out if he can afford to buy a new refrigerator from a local dealer. User A may connect to an ownership management service (OMS) implementing a methodology of the present disclosure in one embodiment, and get the OMS to create an ownership model for the refrigerator he is considering. The OMS of the present disclosure may receive from user A, information such as the machine's cost, make, year, and the financing plan available at the store. Using the specified information, the OMS may generate an ownership model for User A of the perspective refrigerator. This model in one embodiment of the present disclosure may indicate both the initial costs (e.g., down payment and installation fee), as well as the ongoing savings needed to fund (e.g. loan payments) and then finally replace the refrigerator. User A may review the refrigerator's ownership model and decide to go through with the purchase. In one embodiment of the present disclosure, the OMS may further transfer funds to cover the down payment and installation of the refrigerator, also setting up automatic savings for the payment of its loan and future replacement. Time passes, with user A using the refrigerator, the loan for it being automatically paid by the OMS and savings for its loan payment and future replacement being automatically compiled in one of User A's saving accounts. When the time comes for the refrigerator to be replaced, e.g., because it breaks down due to age, User A may use his automatically saved funds to buy a new one. In buying the new refrigerator, the methodology described above may be again utilized. Thus, the methodology may be used iteratively.

Scenario #2:

User B would like to find out if she can afford to buy Car Y, now being sold at a local dealer. User B obtains the price for car Y and the financing options. The Ownership Management Service (OMS) of the present disclosure may calculate User B's ownership model for Car Y. This task may involve:
The OMS retrieving a car ownership model template;
The OMS obtaining the needed data, e.g., from User B and/or other third party sources. The data may include the purchase cost, e.g., down payment and monthly payments; Insurance payments; cost and replacement schedule for consumables, e.g., gas, oil, brakes, tires; estimated lifetime of Car Y including resale and trade-in value.
The OMS calculating User B's ownership model for Car Y, this model may include not only the purchase price, but also a savings plan which may provide the needed funds when necessary.

User B may then have the Ownership Management Service compare these costs to her current financial model, for instance, her savings, income not already slated for other charges and fees. Using the comparison, User B decides to buy Car Y. Or alternatively, User B may consider Car X when she sees that Car Y is a larger commitment than she is willing to make.

The Ownership Management Service then may transfer the necessary down payment funds to the dealer; set up an insurance policy for the car, paying the needed start up fee for this; set up automatic savings from User B's income for the ongoing costs of the car, for example, which ongoing costs may include costs associated with maintenance, insurance premiums, car loan payments, and/or others.

Time passes, and User B drives the purchased car, periodically paying for usage, e.g., gas and oil charges using the money automatically saved for the car by the Ownership Management Service, for instance, with each such expenditure being logged by the Ownership Management Service.

The Ownership Management Service may periodically update the ownership model for User B's Car Y. The updates may include, but are not limited to: changing the estimated cost for gas (e.g., given that User B turns out to be buying gas more frequently than previously estimated, and given that the cost of gas goes up); increasing the amount of needed savings needed to maintain the car, e.g., given an unexpected expenditure due to a repair, e.g., from an accident.

The Ownership Management Service may also calculate alternatives to User B's continuing to own Car Y, e.g., replacing it by either selling it and using the resulting funds or trading it in. This analysis may also include the complete calculation of buying and funding the ownership of a new car. For example, the OMS may obtain the purchase price and funding models for a new Car Z, build an ownership model for it and then compare the new ownership model to the current one. Perhaps, in total, User B could trade in her current car and buy and own a new one for only an additional saving of $10.00/month. User B reviews the continued ownership choice and decides to replace Car Y.

The Ownership Management Service may further request bids for the car from dealers and or the public. The Ownership Management Service may also collect all responses and provide a summary for User B. Using the prepared data, User B may make the decision of how best to let go of Car Y.

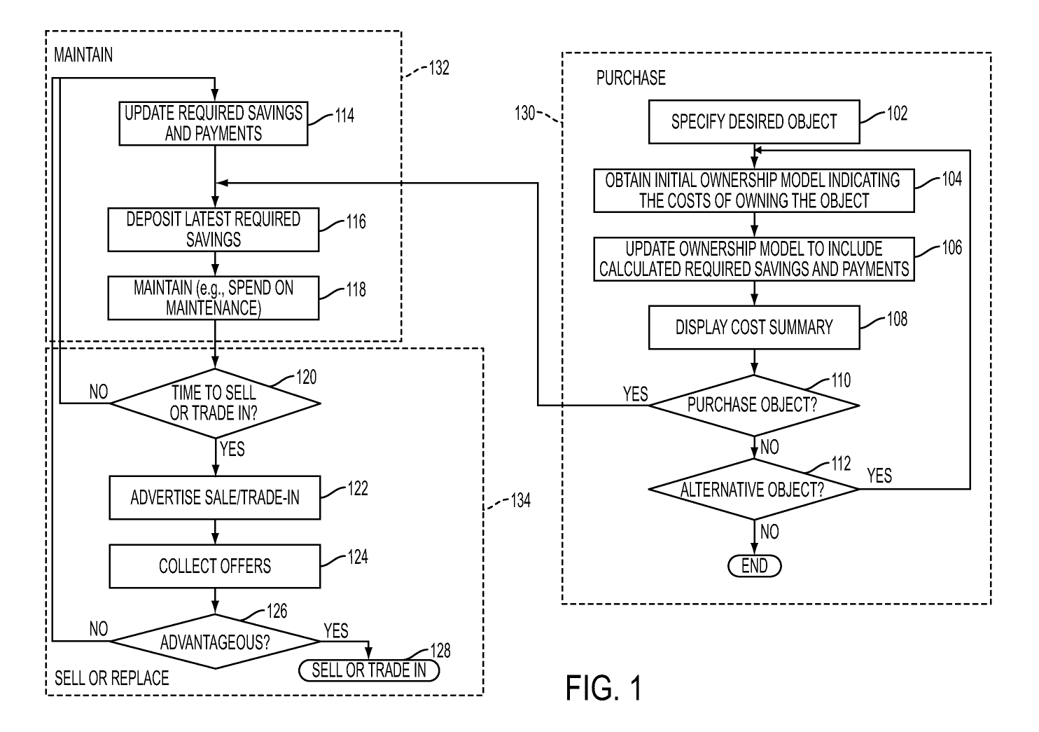

FIG. 1 is a flow diagram illustrating a methodology of the present disclosure in one embodiment. The methodology in one embodiment of the present disclosure may be provide three different functionalities, e.g., purchase 130, maintain 132, and sell or replace 134. Those functions may be utilized individually or together in combination. At 102, an identification or specification of an object desired to be purchased is received. For instance, a user may input such specification via a user interface provided by an ownership management service, which may be embodied as an application program, for instance, running on a user's computing device such as a smartphone or others.

At 104, an ownership model associated with the object may be obtained or built. The ownership model may include the cost of maintaining object, the cost of insuring object, the cost of replacing object, and/or others. The ownership model may also include the cost of purchasing the object, possibly including ongoing loan repayments. The ownership model may further include a suggested time/date to sell, trade-in or otherwise disposing of the object. The ownership model may yet further include an indication of when (or how frequently) payments will be required. For instance, in the case where the object is an automobile, how frequently gas will be required or when the brakes will have to be replaced, and/or others. In one embodiment of the present disclosure, the cost information in the ownership model, not only indicates how much money is needed, but also an estimated schedule of when each expenditure will have to be made. For example, gas has to be purchased every other week, with the estimated cost equaling the size of target automobile's fuel tank times the current cost of gas (e.g., $4/gallon*10 gallon tank=$40 every other week). As another example, auto insurance estimates can be obtained, for instance, from services or facilities that may offer such estimates (e.g., http://www. compuquotes. com/average cost of insurance.html#auto), such estimates including indication that such fees only need to be paid at the beginning of each year. Other costs, such as routine maintenance (oil changes and brake replacement) can also be obtained, each entry including estimation of when payment will be needed (e.g., every 3 months for oil changes and every 2 years for brakes). The cost information in the ownership model may include,
Cost:
   $40 for gas every other week
   $1200 for insurance each year
   $Z for maintenance every P period.

At 106, the required savings and payments may be computed. These calculations determine not only the net amount of money required, but a schedule of savings and payments are made in one embodiment of the present disclosure. For example, in the case of an automobile, money should be put aside each week to pay for gas, with gas purchases (payments) being made every other week; So, if $40 is required every other week, the owner should be able to save $20 each to be able to cover the cost for each payment in time. Similarly, since the estimated cost of insurance is $1200/year, the user must be able to save $100 each month or, alternatively, the entire $1200 by year's end.
Savings:
   $20 each week for gas
   $100 each month for insurance

At 108, the cost summary may be displayed, for instance, via the user interface on the user's computing device. This summary may include both the costs schedule from step 104 as well as the savings schedule from step 106 in one embodiment of the present disclosure.

At 110, the user may decide whether to purchase the object, for instance, based on the cost summary. If the user decides not to purchase the object, the user may specify that an alternative object may be desired at 112 and the system or methodology of the present disclosure may repeat or iterate the method at 102.

If the user decides to purchase the object at 110, then the ownership management system of the present disclosure may automatically schedule savings to fund the ownership of the object based on the ownership model. Thus, for example, at 116, the amount for saving may be automatically deposited, and for instance, this step may be performed repeatedly per every predetermined period (e.g., monthly), to pay for the ownership of the object.

In addition, the cost model associated with the object may be updated, for instance, to account for fluctuations in the price such as increase in gas price, higher usage rates (e.g., caused by having to drive longer distance, and/or others), and/or to account for other changes. Based on the updates, for instance, shown at 114, the savings and payments may be automatically updated.

At 118, the object may be maintained according to the cost and savings schedules from the ownership model. E.g., saving $20 each week for gas and $100 each month for insurance, and then purchasing $40 of gas every other week and $1200 of insurance at the beginning of each new year.

At 120, the user may consider whether to continue to own the object, e.g., given the updated ownership model. If the user decides to keep the object, the method may continue at 114. If the user decides to sell or trade-in the object (or dispose of the object in other ways), at 122, the ownership management system of the present disclosure in one embodiment may automatically advertise for the sale or trade-in of the object, and collect offers at 124. At 126, the ownership management system of the present disclosure in one embodiment may determine whether the offer is advantageous to the user to accept. In one embodiment of the present disclosure, the OMS may make this determination by comparing the collected offer to the current level of required savings, such as, for example, where the offer is for a purchase price of the current automobile of $5000, while the current required savings is $3000/year to cover all required up keep, insurance and operating costs (e.g., gas). Other comparisons of proposed offers to cost and savings levels may be included. If the offer is deemed advantageous, then at 128, the automatically saved funds may be used to pay for the replacement of the object.

In a further embodiment of the present disclosure, the OMS may determine a recommendation at step 126, and provide it to the user, e.g., leaving final decision at step 126 to be made by the user instead of automatically by the OMS. Thus, in one embodiment of the present disclosure, the decision to purchase may be made automatically or manually.

Yet in another aspect, the ownership management system of the present disclosure may use the updated ownership model in conjunction with the user's income, bills and savings to calculate and then indicate whether the user can afford to continue to own the object.

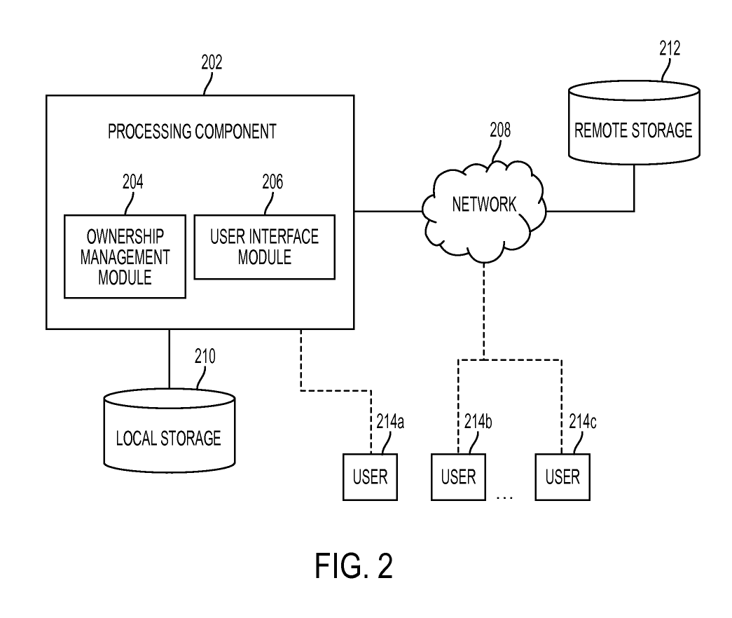

FIG. 2 is a diagram illustrating components of the present disclosure in one embodiment. A processing component 202 may include one or more processor, a computer and/or integrated circuit, that may execute an ownership management module 204 and user interface module 206. The processing component 202 need not be a single device, rather may be a pluralities of devices, whether co-located or distributed across different machines, for instance, locally or remotely. The ownership module 204 may run on the processing component 202 and provide one or more functionalities described above with reference to FIG. 1. The user interface module 206 may also run on the processing component 202 providing interfacing capabilities between the ownership management module and one or more users 214a. 214b. 214c. One or more users may interact with the ownership management module 204 via the user interface 206, locally (e.g., shown at 214a) or remotely (e.g., shown at 214b, 214c) over a network 208. The processing component 202 may be connected to a storage device locally, for example, as shown at 210 or remotely over a network, for example, as shown at 212, or both, and may store and access data for processing the ownership management module 204 and the user interface module 206.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The systems and methodologies of the present disclosure may be carried out or executed in a computer system that includes a processing unit, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen for presenting output displays and providing a display through which the user may input data and interact with the processing system, for instance, in cooperation with input devices such as the keyboard and mouse device or pointing device. The computer processing system may be also connected or coupled to one or more peripheral devices such as the printer, scanner, speaker, and any other devices, directly or via remote connections. The computer processing system may be connected or coupled to one or more other processing systems such as a server, other remote computer processing system, network storage devices, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A method for facilitating ownership of a given object, comprising:
generating, by a processor, an ownership model associated with the given object based on receiving information associated with the given object, the ownership model comprising at least cost of purchasing the given object, cost of maintaining the given object, cost of replacing the given object, cost of insuring the given object, and estimated schedule of when expenditures associated with keeping the given object need to be made;
updating the ownership model automatically and periodically to account for fluctuations in the expenditures associated with keeping the given object;
scheduling automatic saving to fund initial and ongoing cost of the ownership of the given object based on the ownership model; and
automatically depositing funds periodically over time for paying for the initial and ongoing cost of the ownership of the given object with the automatically saved funds.

2. The method of claim 1, further including:
receiving instructions based on the updated ownership model as to whether to continue to own the given object.

3. The method of claim 2, further including:
automatically advertising for sale or trade in of the given object; and
collecting offers.

4. The method of claim 2, further including:
applying the updated ownership model in conjunction with user's income, bills and savings to calculate and indicate whether the user can afford to continue to own the given object.

5. The method of claim 1, further including:
replacing the given object with another object using the automatically saved funds.

6. (canceled)

7. The method of claim 1, wherein the ownership model further comprises ongoing loan repayments.

8. The method of claim 1, wherein the ownership model includes a suggested time and/or date to sell, trade-in or dispose the given object.

9. The method of claim 1, wherein the ownership model includes indication of when and/or how frequently payments will be required.

10. The method of claim 1, wherein the ownership model includes a savings schedule to cover costs of owning the given object.

11. A non-transitory computer readable storage medium storing a program of instructions executable by a machine to perform a method of facilitating ownership of a given object, comprising:
generating, by a processor, an ownership model associated with the given object based on receiving information associated with the given object, the ownership model comprising at least cost of purchasing the given object, cost of maintaining the given object, cost of replacing the given object, cost of insuring the given object, and estimated schedule of when expenditures associated with keeping the given object need to be made;
updating the ownership model automatically and periodically to account for fluctuations in the expenditures associated with keeping the given object;
scheduling automatic saving to fund initial and ongoing cost of the ownership of the given object based on the ownership model; and
automatically depositing funds periodically over time for paying for the initial and ongoing cost of the ownership of the given object with the automatically saved funds.

12. The computer readable storage medium of claim 11, further including:
receiving instructions based on the updated ownership model as to whether to continue to own the given object.

13. The computer readable storage medium of claim 12, further including:
automatically advertising for sale or trade in of the given object; and
collecting offers.

14. The computer readable storage medium of claim 12, further including:
applying the updated ownership model in conjunction with user's income, bills and savings to calculate and indicate whether the user can afford to continue to own the given object.

15. The computer readable storage medium of claim 11, further including:
replacing the given object with another object using the automatically saved funds.

16. (canceled)

17. The computer readable storage medium of claim 11, wherein the ownership model further comprise ongoing loan repayments.

18. The computer readable storage medium of claim 11, wherein the ownership model further comprise a suggested time and/or date to sell, trade-in or dispose the given object.

19. The computer readable storage medium of claim 11, wherein the ownership model includes indication of when and/or how frequently payments will be required.

20. The computer readable storage medium of claim 11, wherein the ownership models includes a savings schedule to cover costs of owning the given object.

21. A system for facilitating ownership of a given object, comprising:
a processor;
an ownership management module operable to execute on the processor and further operable to generate an ownership model associated with the given object based on receiving information associated with the given object, the ownership model comprising at least cost of purchasing the given object, cost of maintaining the given object, cost of replacing the given object, cost of insuring the given object, and estimated schedule of when expenditures associated with keeping the given object need to be made, the ownership management module further operable to update the ownership model automatically and periodically to account for fluctuations in the expenditures associated with keeping the given object, the ownership management module further operable to schedule automatic saving to fund initial and ongoing cost of the ownership of the given object based on the ownership model, the ownership management module further operable to automatically transfer funds to pay for the initial and ongoing cost of the ownership of the given object with the automatically saved funds.

22. (canceled)

23. The system of claim 21, wherein the ownership model further comprises ongoing loan repayments.

24. The system of claim 21, wherein the ownership model further comprises a suggested time and/or date to sell, trade-in or dispose the given object.
